(19) United States
(12) Patent Application Publication
(10) Pub. No.: US 2006/0256791 A1
(43) Pub. Date: Nov. 16, 2006

(54) Communications method, network, and information processing apparatus

(75) Inventor: Satoshi Deishi, Ibaraki-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/429,135

(22) Filed: May 5, 2006

(30) Foreign Application Priority Data
May 16, 2005 (JP) JP2005-143061

(51) Int. Cl. H04L 12/56

(52) U.S. Cl. 370/392; 370/401

(57) ABSTRACT

Each PC is directly associated with at least another PC such that all the PCs in a network are directly or indirectly related with each other. When one of these PCs instructs all the other PCs to execute predetermined processing, the instruction source PC transmits instruction data to execute the predetermined processing with identifying information for this instruction data to another PC with which the instruction source PC is directly associated, and the PC that received the instruction data, when it has not previously received identifying information expressing the same content as the identifying information received with the instruction data, executes the predetermined processing according to that instruction data, and forwards the received instruction data and identifying information to another PC with which that PC is directly associated. Thus, the load placed on a specified apparatus that occurs when obtaining information for the nodes that configure a network is reduced.

This application is based on Japanese Patent Application No. 2005-143061 filed on May 16, 2005, the contents of which are hereby incorporated by reference.

### BACKGROUND OF THE INVENTION

1. Field of the Invention

The present invention relates to the configuration of a network and a data communications method and the like.

2. Description of the Related Art

Technology has become widespread in which a network is formed by connecting a plurality of information processing apparatuses (nodes) such as personal computers with communications lines, and data is exchanged among these information processing apparatuses. P2P (peer-to-peer) networks are particularly widely adopted in small-scale offices and the like because they can be constructed more simply than client-server networks.

However, in a P2P network, management of information relating to the configuration of the network and the like becomes more complicated as the number of information processing apparatuses in the network increases. Management is particularly likely to become complicated in the case of a pure P2P network, in which a managing apparatus (for example, such as a DHCP (Dynamic Host Configuration Protocol) server) is not present.

Accordingly, a method called “flooding is ordinarily used to obtain necessary node information. With this method, data is flowed like a flood to all of the nodes in the network. Each node obtains data that it requires, and discards data that it does not require.

In order to look up the attributes (such as IP address or host name) of all nodes, a method is also often used in which data that includes a predetermined command is transmitted (flooded) with a broadcast address as the destination. A node that has received the command data replies with its attribute information to the command source node according to that command.

Other than the above, methods such as those described in Japanese unexamined patent publication No. 2004-164625 and Japanese unexamined patent publication No. 2004-266622 have been proposed for data communications among a plurality of nodes. According to the method described in Japanese unexamined patent publication No. 2004-164625, when data has been propagated on the network, propagation history information is shared across at least the three generations of the data transmission source, the node itself, and the data transmission destination, and stored in each node. Thus, it is possible to track the data propagation path using the propagation history information.

According to the method described in Japanese unexamined patent publication No. 2004-266622, a terminal apparatus n transmits an information request to a server 5 when the terminal apparatus n starts driving and when an information request transmission command and address information are received from a terminal apparatus n−1. When the server 5 has received the information request from the terminal apparatus n, it manages storage of this terminal apparatus n, and transmits information and address information for a terminal apparatus n+1 to the terminal apparatus n. When the terminal apparatus n has received the information and address information for the terminal apparatus n+1 from the server 5, after transmitting an information request transmission command and its own terminal apparatus address information to the terminal apparatus n+1, the terminal apparatus n transmits the information received from the server 5 to the terminal apparatus n−1 from which it received the information request transmission command.

As stated above, P2P networking is used for exchanging content on the Internet and for configuring simple networks in small-scale offices. Thus, there are few scenarios in which information for all nodes is gathered. However, from the present time forward, from the viewpoint of security, tight management of all nodes will be strongly desired when networks are introduced in government and corporate offices and the like.

However, according to a conventional flooding method, when an inquiry is made to all nodes with respect to a particular item (for example, such as an IP address), because traffic is generated simultaneously, communications over the entire network are likely to be delayed. Also, there is a large load placed on the apparatus that is the source of the inquiry. In particular, the communications delay grows longer as the network increases in scale. Also, the load placed on the apparatus that is the source of the inquiry or on a specified apparatus such as a hub increases.

With the method described in Japanese unexamined patent publication No. 2004-164625, it is not possible to solve the above problems. With the method described in Japanese unexamined patent publication No. 2004-266622, when data such as video content is simultaneously delivered to a plurality of terminal apparatuses, the server load can be decreased. However, it is not possible to decrease the traffic when making an inquiry with respect to IP addresses and the like, or to decrease the load on the source of the inquiry.

### SUMMARY OF THE INVENTION

In view of such problems, it is an object of the present invention to decrease the load placed on a specified apparatus that occurs when obtaining information for the nodes that configure a network more than with the conventional technology. Further, it is an object of the present invention to decrease the traffic that occurs when obtaining information for the nodes that configure the network more than with the conventional technology.

According to one aspect of the present invention, a communications method in a network configured by a plurality of nodes, includes directly associating each node with at least one other node, such that all of the nodes that configure the network are directly or indirectly related. When an instruction source node among the nodes that configure the network causes all of the other nodes to execute predetermined processing, the instruction source node transmitting an instruction to execute the predetermined processing, along with issued identifying information unique to that instruction, to another node with which the instruction source node is directly related, and the node that received the instruction, when it has not previously received identifying information expressing the same content as the identifying information received with the instruction, executing the predetermined processing according to the instruction, and transmitting the received instruction and identifying information to another node that is directly associated with the node.

According to the present invention, it is possible to decrease the load placed on a specified apparatus that occurs when obtaining information for the nodes that configure a network more than with the conventional technology. According to the invention, it is further possible to decrease the traffic that occurs when obtaining information for the nodes that configure the network more than with the conventional technology.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of an overall configuration of a network.

FIG. 2 is a diagram showing an example of a hardware configuration of a terminal apparatus.

FIG. 3 is a diagram showing an example of a functional configuration of a terminal apparatus.

FIGS. 4A and 4B show examples of logical topologies of terminal apparatuses.

FIGS. 5A to 5D show examples of connection tables of terminal devices associated with one another as shown in FIG. 4A.

FIGS. 6A to 6H show examples of connection tables of terminal devices associated with one another as shown in FIG. 4B.

FIG. 7 is a flowchart for explaining a processing flow of an instruction source terminal apparatus.

FIG. 8 shows an example of a format of instruction data.

FIG. 9 is a flowchart for explaining a processing flow of a terminal apparatus other than the instruction source terminal apparatus.

FIG. 10 is a diagram for explaining an example of a transition of instruction data in the logical topology as shown in FIG. 4A.

FIG. 11 is a diagram for explaining an example of a transition of instruction data in the logical topology as shown in FIG. 4B.

FIGS. 12A and 12B are diagrams showing modified examples of a logical topology of a network.

### DESCRIPTION OF THE PREFERRED EMBODIMENTS

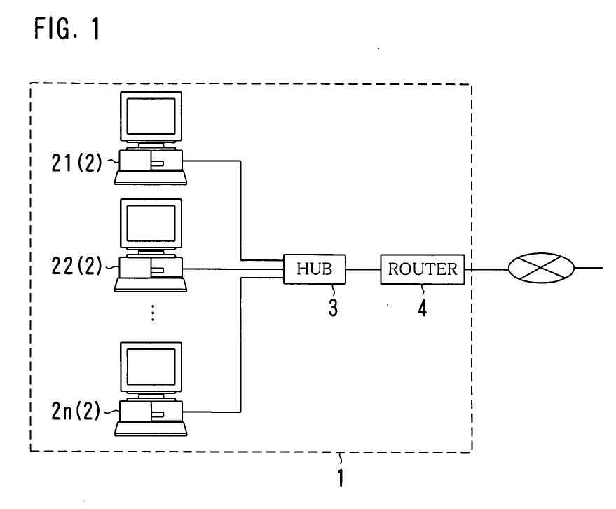

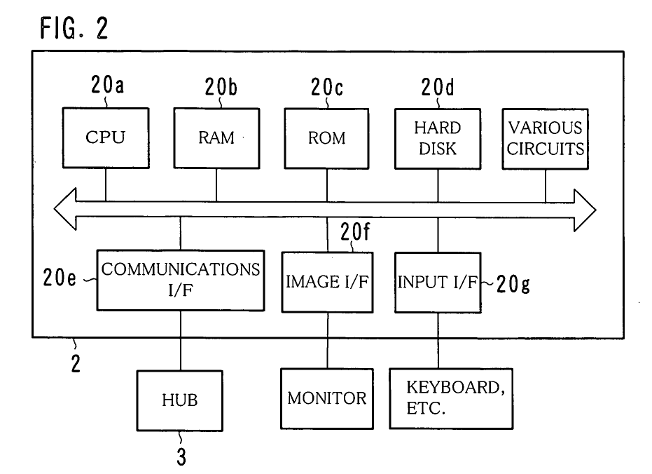

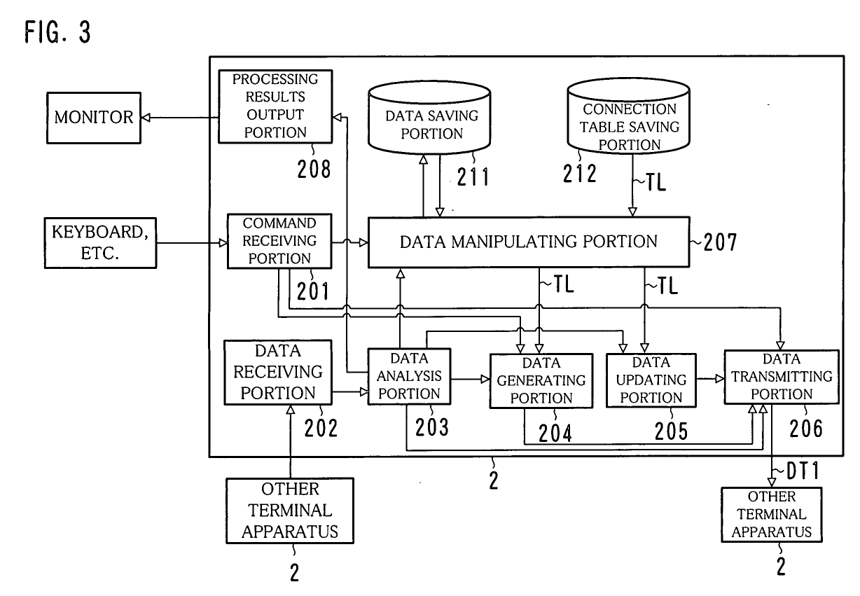

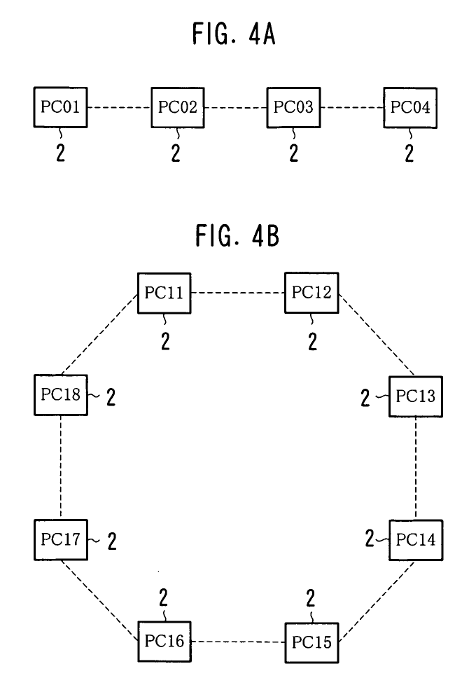

FIG. 1 is a diagram showing an example of an overall configuration of a network 1, FIG. 2 is a diagram showing an example of a hardware configuration of a terminal apparatus 2, FIG. 3 is a diagram showing an example of a functional configuration of the terminal apparatus 2 and FIGS. 4A and 4B show examples of logical topologies of the terminal apparatuses 2.

As shown in FIG. 1, the network 1 in the present invention is a LAN (Local Area Network) configured by nodes such as a plurality of the terminal apparatuses 2 (21, 22, . . . , 2n), a switching hub 3, and a router 4. These terminal apparatuses 2 are connected to the switching hub 3 in a star topology with twisted pair cables. The switching hub 3 and the router 4 are also connected with a twisted pair cable. Following is a description of a case in which data communication is performed between the terminal apparatuses 2 that are among these nodes.

The terminal apparatuses 2 are apparatuses in which processing for data input and output between a terminal apparatus 2 and another apparatus is executed, such as a personal computer, workstation, or printer. Following is a description of an example in which a personal computer is used as a terminal apparatus 2.

As shown in FIG. 2, a terminal apparatus 2 is configured from a CPU 20a, a RAM 20b, a ROM 20c, a hard disk 20d, a communications interface 20e, an image interface 20f, an input interface 20g, and various other circuits or apparatuses and the like.

The communications interface 20e is a NIC (Network Interface Card), and is connected to any port of the switching hub 3 via a twisted pair cable. The image interface 20f is connected to a monitor, and outputs an image signal for displaying a screen to the monitor. The input interface 20g is connected to an input apparatus such as a keyboard or mouse, and inputs a signal that expresses the content of a user's operation from these input apparatuses.

As shown in FIG. 3, programs and data for realizing functions such as that of a command receiving portion 201, a data receiving portion 202, a data analysis portion 203, a data generating portion 204, a data updating portion 205, a data transmitting portion 206, a data manipulating portion 207, a screen output portion 208, a data saving portion 211, and a connection table saving portion 212 are stored on the hard disk 20d. These programs and data are read out to the RAM 20b as necessary, and the programs are executed by the CPU 20a.

A host name (machine name), IP address, and MAC address are given to each terminal apparatus 2, in order to distinguish each terminal apparatus from other terminal apparatuses. IP addresses are given according to the rules of the network 1. MAC addresses are set in advance by the manufacturer of the communications interface 20e. Host names can be freely given by an administrator or the like of the network 1. In the present embodiment, a host name in the manner of “PC01”, “PC02”, . . . , is given to each terminal apparatus 2.

Also, these terminal apparatuses 2 are assumed to be disposed in a virtual space as shown for example by either FIG. 4A or FIG. 4B. As shown by the dotted lines, each terminal apparatus 2 is associated with at least one other terminal apparatus 2 adjacent in the virtual space. Moreover, due to these associations, all of the terminal apparatuses 2 are directly or indirectly related to each other. “Directly related” means connected by one dotted line in FIG. 4 (for example, related in the manner of PC02 and PC03 in FIG. 4A), and “indirectly related” means connected by at least two dotted lines and at least one node (for example, related in the manner of PC01 and PC03 in FIG. 4A). A terminal apparatus 2 transmits data to another terminal apparatus 2 with which it is directly associated. Below, “associated” means directly associated, unless particularly stated otherwise.

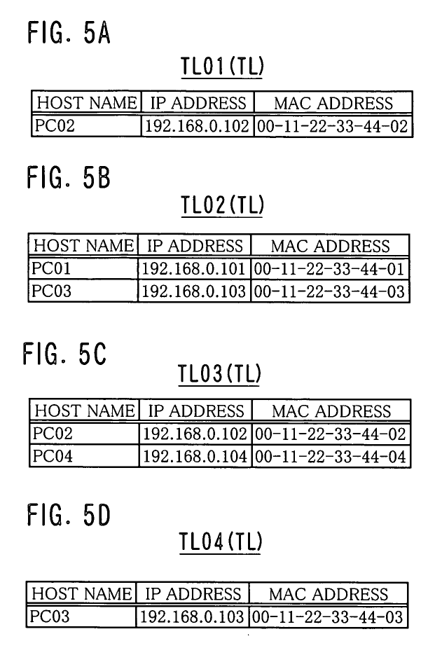

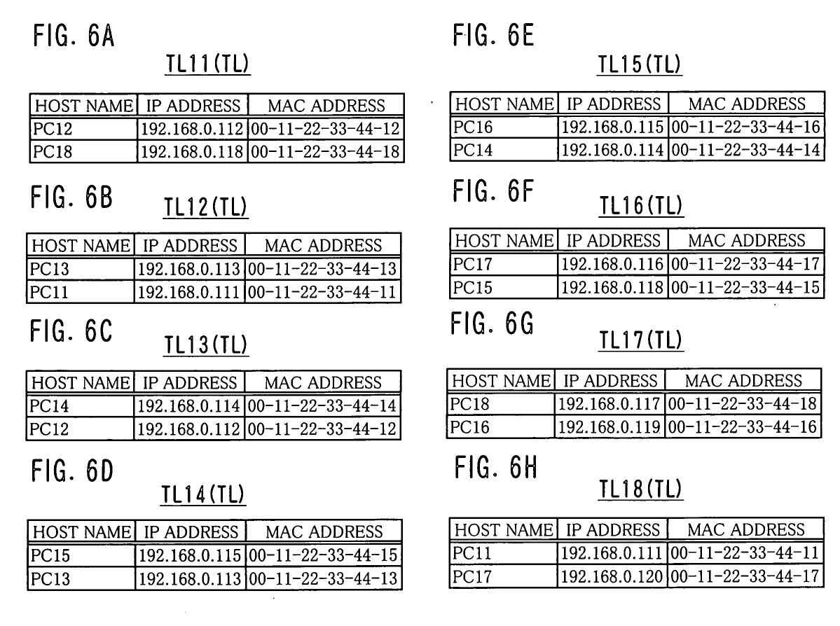

FIGS. 5A to 5D show examples of connection tables of the terminal devices 2 (PC01-PC04) associated with one another as shown in FIG. 4A, and FIGS. 6A to 6H show examples of connection tables of the terminal devices 2 (PC11-PC18) associated with one another as shown in FIG. 4B.

Following is a detailed description of the content of processing of each portion of the terminal apparatus 2 shown in FIG. 3.

The data saving portion 211 saves data used by an OS, application software, or the like, data created by a user with application software, or various other data, as files. Other than such files, the data saving portion 211 stores identifying information for instruction data DT1 that has been received up to the present. Instruction data DT1 will be described later.

The connection table saving portion 212 saves a connection table TL that expresses a list of attributes such as the host name, IP address, and MAC address of other terminal apparatuses 2 that are associated with that terminal apparatus 2. For example, connection tables TL01 to TL04 as shown in FIGS. 5A to 5D are respectively saved in the connection table saving portions 212 in PC01 to PC04 in FIG. 4A. Also, connection tables TL11 to TL18 as shown in FIGS. 6A to 6H are respectively saved in the connection table saving portions 212 in PC11 to PC18 in FIG. 4B. The content of these connection tables TL is created in advance by an administrator based on the associations of each terminal apparatus 2.

The command receiving portion 201 receives a command designated by a user operating a keyboard, mouse, or the like, and causes each portion to execute processing according to that command.

From among packets flowed through the network 1, the data receiving portion 202 receives packets necessary to that terminal apparatus 2.

The data analysis portion 203 extracts a portion of the necessary data from among the packets received and analyzes the contents of that data. Also, the data analysis portion 203 gives an instruction to each portion of the terminal apparatus 2 to execute processing according to the results of that analysis. For example, it gives an instruction to the data manipulating portion 207 to save data in the data saving portion 211, and gives an instruction to the data generating portion 204, the data updating portion 205, and the data transmitting portion 206 to generate data that responds with the attributes (such as the IP address) of the terminal apparatus 2 itself and to transmit that data to the source of the inquiry.

The data generating portion 204 generates data based on an instruction from the command receiving portion 201 or the data analysis portion 203. The data updating portion 205 updates existing data based on an instruction from the command receiving portion 201 or the data analysis portion 203. The data transmitting portion 206 converts data generated by the data generating portion 204 or updated by the data updating portion 205 to packets, and transmits the packets to another terminal apparatus 2 based on an instruction from the command receiving portion 201 or the data analysis portion 203.

The data manipulating portion 207 performs processing related to a file saved in the data saving portion 211 of that terminal apparatus 2, based on an instruction from the command receiving portion 201 or the data analysis portion 203.

The screen output portion 208 performs processing for displaying a screen for giving a message or instruction to a user who operates that terminal apparatus 2, a screen for a user to input a processing instruction, a screen for displaying the results of processing, and the like on a monitor.

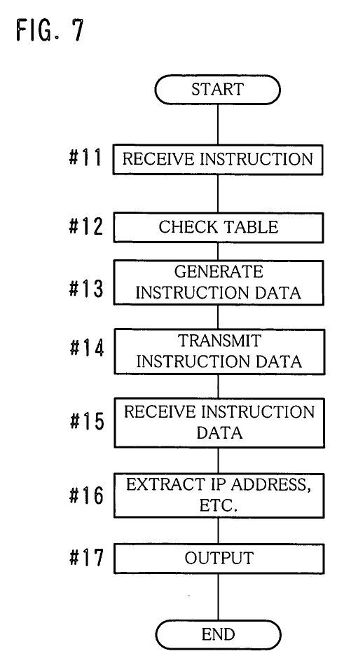

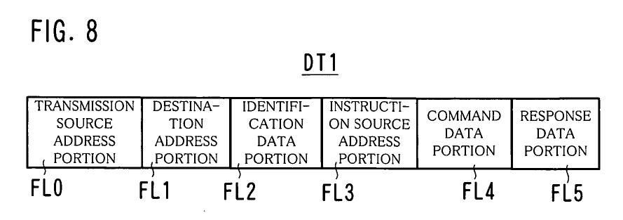

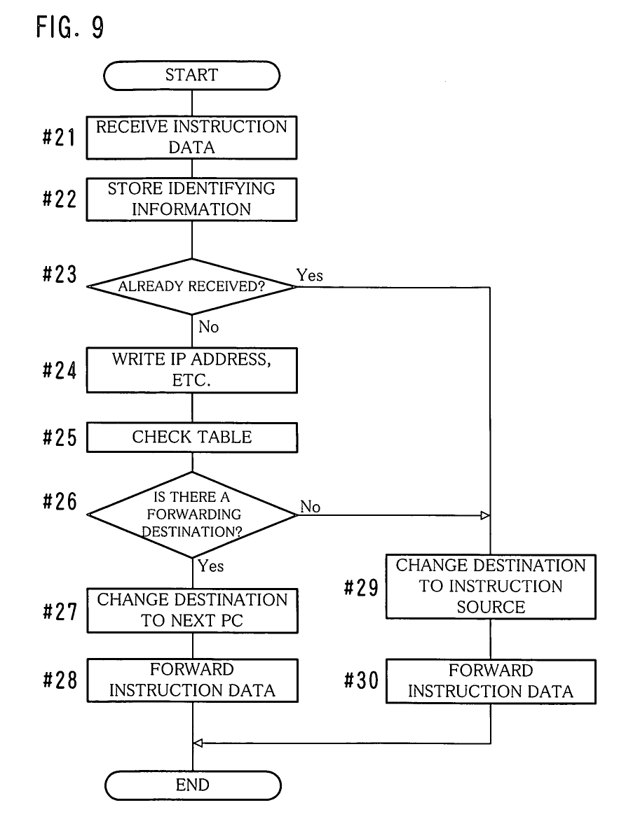

FIG. 7 is a flowchart for explaining a processing flow of an instruction source terminal apparatus 2M, FIG. 8 shows an example of a format of the instruction data DT1 and FIG. 9 is a flowchart for explaining a processing flow of a terminal apparatus 2 other than the instruction source terminal apparatus 2M.

Following is a detailed description of the content of processing of each portion in the terminal apparatuses 2 with reference to flowcharts and the like, for an example in which the user of a particular terminal apparatus 2 has designated a command to respond with the IP address and has designated a broadcast address as a parameter that indicates the executing entity for that command. Below, in order to distinguish the terminal apparatus 2 in which a command has been designated by a user, and that instructs that the processing of this command be executed, from other terminal apparatuses 2, that terminal apparatus is sometimes referred to as the “instruction source terminal apparatus 2M”.

In the instruction source terminal apparatus 2M, when the command receiving portion 201 has received the content of a command and a parameter specified by the user (#11 in FIG. 7), the data generating portion 204 generates the instruction data DT1 in the following manner.

First, empty data in a format like that shown in FIG. 8 is prepared. The other terminal apparatuses 2 indicated in the connection table TL that is saved in the connection table saving portion 212 of that instruction source terminal apparatus 2M itself are checked (#12).

The MAC addresses or host names for the other terminal apparatuses 2 that were checked are written to a destination address portion FL1. The MAC address or host name for the instruction source terminal apparatus 2M itself are written to both a transmission source address portion FL0 and an instruction source address portion FL3. Identifying information (for example, such as a value combining the time and date that the user's designation was received and the identifying information for the instruction source terminal apparatus 2M) for distinguishing the current instruction data DT1 from previously generated instruction data DT1 is issued, and this is written to an identification data portion FL2. The command that has been designated by the user is written to a command data portion FL4. The IP address and the MAC address or host name for the instruction source terminal apparatus 2M itself are written to a response data portion FL5. In this manner, the instruction data DT1 is generated (#13).

The data transmitting portion 206 converts the instruction data DT1 that has been generated into packets and transmits that data to the address shown in the destination address portion FL1 for that instruction data DT1 (#14).

The packets of the instruction data DT1 that have been transmitted from the instruction source terminal apparatus 2M temporarily arrive at the switching hub 3. The switching hub 3 transmits these packets that have arrived to the terminal apparatus 2 connected to the port corresponding to the address shown in the destination address portion FL1. In this manner, the switching hub 3 fulfills a role of relaying data such as the instruction data DT1 to only a destination terminal apparatus 2. The transmission and reception of data between two terminal apparatuses 2, described later, is likewise performed via the switching hub 3.

In terminal apparatuses 2 other than the instruction source terminal apparatus 2, processing is performed with a procedure as shown in FIG. 9. When the data receiving portion 202 in FIG. 3 receives instruction data DT1 (#21 in FIG. 9), the data saving portion 211 stores the identifying information for that instruction data DT1 shown in its identification data portion FL2 (#22), and the data analysis portion 203 instructs the data updating portion 205 and the data transmitting portion 206 to execute processing that corresponds to the command shown in the command data portion FL4 for that instruction data DT1.

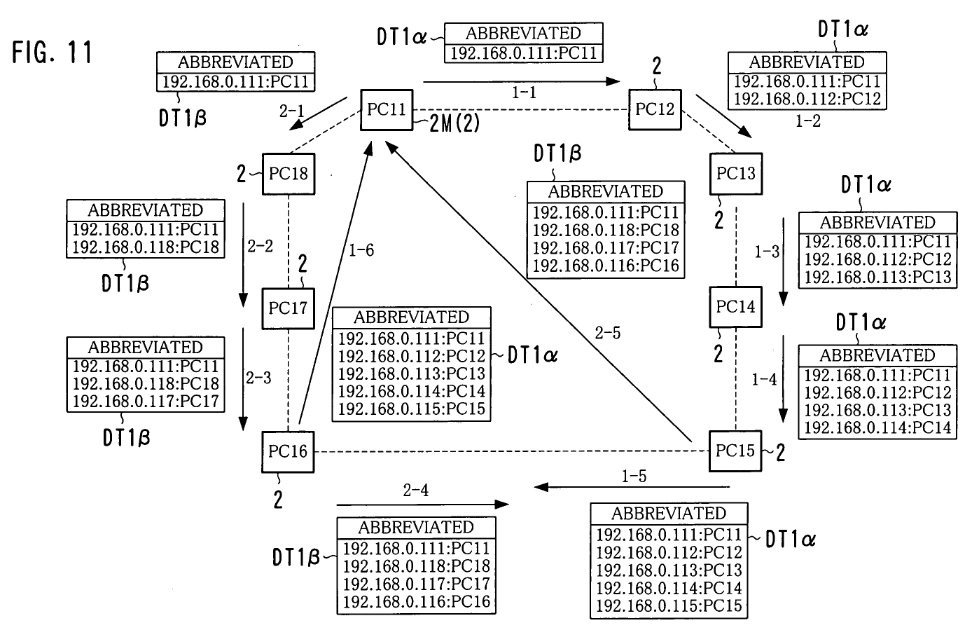

As described later in FIG. 11, there may be instances when a plurality of instruction data DT1 having the same identifying information (i.e., the same command, issued at the same time from the same instruction source terminal apparatus 2M) is delivered to the terminal apparatus 2. With respect to the second and subsequent such instruction data DT1 (Yes in #23), the data updating portion 205 omits the processing in steps #24 and #25, and rewrites the value of the destination address portion FL1 to the value shown in the instruction source address portion FL3, i.e., a value that indicates the instruction source terminal apparatus 2M (#29). Then, the data transmitting portion 206 transmits that instruction data DT1 to the destination that has been rewritten (#30).

When the identifying information for the received instruction data DT1 is not equal to any identifying information for instruction data DT1 that has been previously received (No in #23), the data updating portion 205 adds the IP address and the MAC address or host name for the received instruction data DT1 to the response data portion FL5 for that instruction data DT1 (#24).

Further, a check is performed of whether or not a terminal apparatus 2 other than the terminal apparatus 2 that transmitted that instruction data DT1 (i.e., the terminal apparatus 2 shown in the transmission source address portion FL0 for that instruction data DT1) is shown in its own connection table TL (#25). When the result is that a terminal apparatus 2 was found (Yes in #26), processing is performed as follows in order to forward the instruction data DT1 to the terminal apparatus 2 that was found.

That is, when only one terminal apparatus 2 was found, the value of the destination address portion FL1 in the instruction data DT1 for that terminal apparatus 2 is rewritten to the MAC address or host name for the found terminal apparatus 2. When a plurality of terminal apparatuses 2 were found, their instruction data DT1 is duplicated to become the same as the number of terminal apparatuses 2, and the values of the respective destination address portions FL1 are rewritten to the MAC addresses or host names of the terminal apparatuses 2 that were found (#27). Then, the data transmission portion 206 transmits these sets of instruction data DT1 to the destinations that have been rewritten (#28).

On the other hand, when a terminal apparatus 2 was not found in Step #25 (No in #26), the data updating portion 205 rewrites the value of the destination address portion FL1 in the instruction data DT1 received in Step #21 to the value shown in the instruction source address portion FL3, i.e., a value that indicates the instruction source terminal apparatus 2M (#29). Then, the data transmitting portion 206 transmits that instruction data DT1 to the rewritten destination (#30).

Returning to FIG. 7, in the instruction source terminal apparatus 2M, when instruction data DT1 returns from another terminal apparatus 2 (#15), the data analysis portion 203 extracts the IP address and host name for each terminal apparatus 2 indicated in the response data portion FL5 in that instruction data DT1 (#16), and the screen output portion 208 displays this on a monitor (#17). As described later, there may be times when a plurality of sets of instruction data DT1 returns. Accordingly, a configuration may be adopted in which, after the processing in Step #14, after waiting a predetermined period of time for sets of instruction data DT1 to return, the IP addresses and the like indicated therein are displayed together.

Whether or not instruction data DT1 is data that has returned is known by comparing the identifying information indicated in the identification data portion FL2 of the instruction data DT1 received from another terminal apparatus 2 in Step #15 to the identifying information for the instruction data DT1 transmitted by the instruction source terminal apparatus 2M itself in Step #14. That is, if the identifying information for both is the same, it can be judged that the instruction data DT1 is data that has returned.

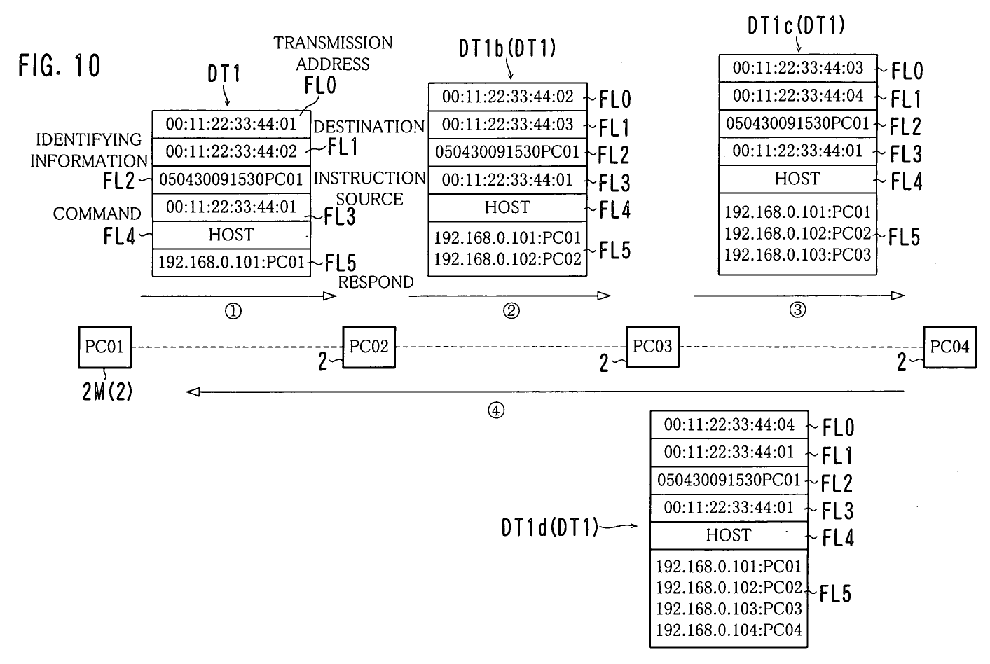

FIG. 10 is a diagram for explaining an example of a transition of the instruction data DT1 in the logical topology as shown in FIG. 4A.

Here, using for example a case in which four terminal apparatuses 2 (PC01 to PC04) are provided in the network 1 with a logical topology as shown in FIG. 4A, and PC01 is the instruction source terminal apparatus 2M, the processing procedure of these terminal apparatuses 2 and the transition of instruction data DT1 are explained with reference to FIG. 10.

In FIG. 10, when a command and a parameter (broadcast address) are input by a user, PC01 creates instruction data DT1 based on that command and parameter, and transmits that instruction data DT1 to the terminal apparatus 2 associated with PC01 itself, i.e., PC02, shown in the connection table TL01 for PC01 itself (see FIG. 5A). This processing corresponds to Steps #11 to #14 in FIG. 7.

When PC02 receives the instruction data DT1, the content of that instruction data DT1 is updated to instruction data DT1b by executing processing according to the command of the command data portion FL4. That is, the IP address and the like of PC02 itself are rewritten to the response data portion FL5. The terminal apparatuses 2 associated with PC02 itself, indicated in the connection table TL02 for PC02 itself (See FIG. 5B), are checked. However, the terminal apparatus 2 that sent the instruction data DT1 to PC02, i.e., the terminal apparatus 2 indicated in the transmission source address portion FL0, is not checked. As a result, in this example PC03 is found. The transmission source address portion FL0 is rewritten to the MAC address of PC02 itself, and the destination address portion FL1 is rewritten to the MAC address of the terminal apparatus that was found, i.e., PC03. Then, instruction data DT1b is transmitted to the destination address, i.e., PC03. This processing corresponds to the processing of Steps #21 to #28 in FIG. 9.

When PC03 receives the instruction data DT1b, same as in the case of PC02, by executing processing according to the command, PC03 writes the IP address and the like of PC03 itself to the response data portion FL5, rewrites the value of the transmission source address portion FL0 to the MAC address of PC03 itself, and rewrites the destination address portion FL1 to the MAC address of PC04 based on the connection table TL03 (see FIG. 5C). In this way, the instruction data DT1b is updated to instruction data DT1c. Then, the instruction data DT1c is transmitted to PC04. This processing corresponds to Steps #21 to #28 in FIG. 9.

When PC04 receives the instruction data DT1c, by executing processing according to a command, it writes the IP address and the like of PC04 itself to the response data portion FL5. Terminal apparatuses 2 other than PC03, which is the transmission source of the instruction data DT1c, are not shown in the connection table TL04 for PC04 (see FIG. 5D). As described in FIG. 9, in such a case it is necessary to return the instruction data DT1 to the instruction source terminal apparatus 2M (No in #26 in FIG. 9). Accordingly, PC04 rewrites the value of the destination address portion FL1 to the MAC address indicated in the instruction source address portion FL3, i.e., the MAC address of PC1, which is the instruction source terminal apparatus 2M (#29 in FIG. 9). In this way, the instruction data DT1c is updated to instruction data DT1d. Then, the instruction data DT1d is transmitted to PC01.

PC01 extracts the IP address and host name for each terminal apparatus 2 in the network 1 from the response data portion FL5 of the instruction data DT1 (DT1d) that has returned, and displays them on a monitor. This processing corresponds to the processing in #15 to #17 in FIG. 7.

FIG. 11 is a diagram for explaining an example of a transition of the instruction data DT1 in the logical topology as shown in FIG. 4B.

Next, using for example a case in which eight terminal apparatuses 2 (PC11 to PC18) are provided in the network 1 with a logical topology as shown in FIG. 4B, and PC11 is the instruction source terminal apparatus 2M, the processing procedure of these terminal apparatuses 2 and the transition of the instruction data DT1 are explained with reference to FIG. 11.

In FIG. 11, when a command and a parameter (broadcast address) are input by the user, PC11 creates instruction data DT1 based on that command and parameter, and transmits that instruction data DT1 to the other terminal apparatuses 2 associated with PC11 itself, i.e., PC12 and PC18, shown in the connection table TL11 for PC11 itself (see FIG. 6A). That is, with the logical topology in FIG. 11, unlike in the case of FIG. 10, two sets of instruction data DT1 are transmitted to separate terminal apparatuses 2. This processing corresponds to Steps #11 to #14 in FIG. 7. In the description below, the instruction data DT1 addressed to PC12 and the DT1 addressed to PC18 are distinguished as “instruction data DT1α” and “instruction data DT1β”, respectively. Identifying information with the same values is written to the identification data portion FL2 in the instruction data DT1α and DT1β.

The instruction data DT1α is relayed to each terminal apparatus 2 in the clockwise direction, PC11, PC12, PC13, and so on. At this time, the IP addresses and host names for the terminal apparatuses 2 are written in relay order one after another to the response data portion FL5 in the instruction data DT1α. The values for the transmission source address portion FL0 to command data portion FL4 are also appropriately updated as previously explained in FIG. 9. On the other hand, the instruction data DT1 is relayed to each terminal apparatus 2 in the counterclockwise direction, PC11, PC18, PC17, and so on. At this time, the IP addresses and host names for the terminal apparatuses 2 are written in relay order one after another to the response data portion FL5, same as in the case of the instruction data DT1α.

The set of instruction data DT1α and the set of DT1 pass each other at some point while being relayed to the terminal apparatuses 2. In the example in FIG. 11, they pass each other between PC15 and PC16. After they have passed each other, PC15 receives the instruction data DT1β, but because it has already received the instruction data DT1α, this is the second time the instruction data DT1 is received. Also, when PC15 has received the instruction data DT1α, processing is executed according to the command included therein, a response with the IP address of PC15 itself is written to the instruction data DT1α, and this is transmitted to the next terminal apparatus 2. Thus, as described previously in FIG. 9, it is judged that the same instruction data DT1 has already been received (Yes in #23 in FIG. 9), and the instruction data 1β is transmitted to the instruction source terminal apparatus 2M, i.e., PC11, without being transmitted to PC16 (#29 and #30). Likewise, when PC16 receives the instruction data DT1α, because it has already received the instruction data DT1β, the instruction data DT1 is received for a second time. Thus, the instruction data DT1α is transmitted to PC11 without being transmitted to PC15.

In this way, the set of instruction data DT1α and the set of DT1β return to PC11. Then, PC 11 extracts the IP address and host name for each terminal apparatus 2 in the network 1 from the response data portion FL5 of these sets of instruction data DT1, and displays them on a monitor.

According to the present embodiment, when a particular terminal apparatus 2 obtains information indicating the IP addresses of all of the other terminal apparatuses 2, it is possible to lighten the load placed on the terminal apparatus 2 and the hub 3 more than with the conventional technology. Further, it is possible to decrease the traffic between the terminal apparatus 2 and the hub 3, so that the traffic over the entire network can be reduced more than with the conventional technology.

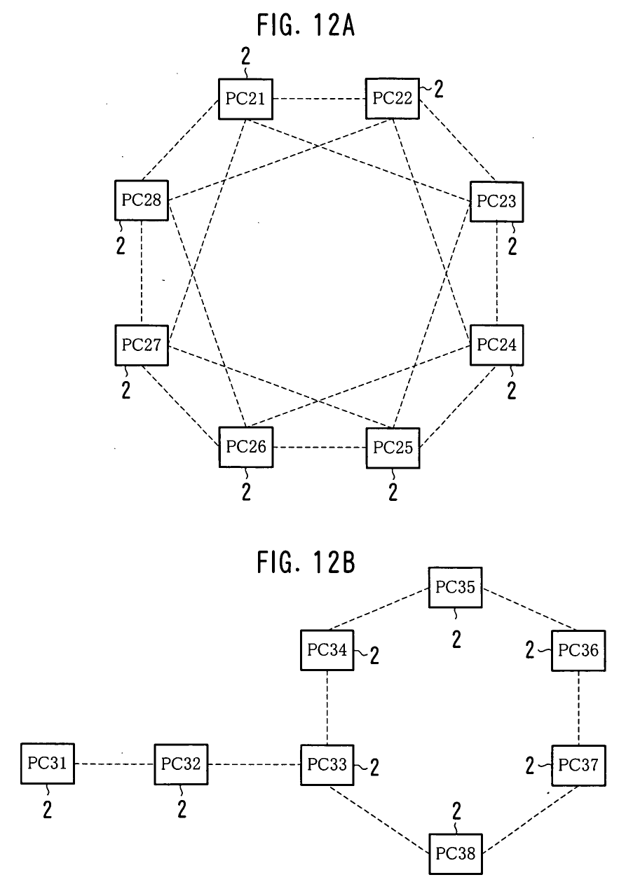

FIGS. 12A and 12B are diagrams showing modified examples of a logical topology of the network 1. In the present embodiment, the content of processing for the terminal apparatuses 2 was described using, as an example, a case in which the terminal apparatuses 2 were disposed with a logical topology as in FIG. 4A or FIG. 4B, but the present invention can also be applied when the terminal apparatuses 2 are disposed with another logical topology. For example, as in FIG. 12A, the present invention can also be applied when the terminal apparatuses 2 are all associated with the same number of terminal apparatuses 2 (in the case of a so-called regular graph).

In the case of a regular graph as shown in FIG. 12A, many closed loops are present. Therefore, even assuming that a condition was given that “instruction data DT1 is not returned to a node from which a command has been received (that is, the previous terminal apparatus 2 from which the instruction data DT1 was sent)”, a problem may occur in which information continues to be forwarded by these closed loops. Accordingly, a configuration may be adopted in which, by way of precaution, the terminal apparatus 2 checks the instruction data DT1 that has been transmitted, and if its own information is recorded therein, that instruction data DT1 is immediately returned to the instruction source terminal apparatus 2M. As a result, it is possible to more reliably eliminate problems of repeated forwarding.

The present invention can also be applied in the case of a topology in which closed-loop sections and dead-end sections are intermingled, as shown in FIG. 12B.

According to the present embodiment, the instruction source terminal apparatus 2M, based on the instruction data DT1 that has been relayed through the other terminal apparatuses 2 and returned, can infer the associations among the terminal apparatuses 2, i.e., the logical topology of the network 1. Further, the terminal apparatus 2M can be used for purposes such as visualizing the topology from the results of that inference, finding a node one wishes to sever from the network, finding a defective node, or reconfiguring the topology in order to improve communications efficiency.

In the present embodiment, a command to respond with the IP address was included in the instruction data DT1, but other commands are also possible. For example, the command may be a command to respond with attributes such as the MAC address, host name, or operating system version. It may also be a command to transmit a public key, document data, image data, audio data, or the like to the instruction source terminal apparatus 2M.

Also, it may be a command to execute processing for a virus check, backup, or the like. Also, a command may be included to attach a file to the instruction data DT1, and to obtain that file. In these cases, a configuration may be adopted in which the processing results are written to the response data portion FL5 of the instruction data DT1 (see FIG. 8). When it is not necessary to report the processing results, processing that returns the instruction data DT1 to the instruction source terminal apparatus 2M (#29 and #30 in FIG. 9) may be omitted.

In the present embodiment, a case was described, by way of example, in which a LAN was used as the network 1, but the present invention can also be applied in a network configured by connecting a plurality of network segments such as a LAN or the Internet via a router or the like (for example, such as an intranet or wide-area Ethernet), or in a virtual LAN or the like. The present invention can also be applied in a wireless LAN.

Other than the above, the configuration of all or a part of the network 1 or the terminal apparatus 2, the content of processing, the order of processing, the content of the tables, the topology, and the like can be appropriately modified in accordance with the gist of the present invention.

The present invention is suitably used for, particularly, managing a pure P2P network in which there is not a managing apparatus.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A communications method in a network configured by a plurality of nodes, comprising:
directly associating each node with at least one other node, such that all of the nodes that configure the network are directly or indirectly related, and
when an instruction source node among the nodes that configure the network causes all of the other nodes to execute predetermined processing,
the instruction source node transmitting an instruction to execute the predetermined processing, along with issued identifying information unique to that instruction, to another node with which the instruction source node is directly related, and
the node that received the instruction, when it has not previously received identifying information expressing the same content as the identifying information received with the instruction, executing the predetermined processing according to the instruction, and transmitting the received instruction and identifying information to another node that is directly associated with the node.

2. A communications method in a network configured by a plurality of terminal apparatuses, comprising:
directly associating each terminal apparatus with at least one other terminal apparatus, such that all of the terminal apparatuses that configure the network are directly or indirectly related, and
when an instruction source terminal apparatus among the terminal apparatuses that configure the network causes all of the other terminal apparatuses to execute predetermined processing,
the instruction source terminal apparatus transmitting instruction information indicating an instruction to execute the predetermined processing, along with identifying information for distinguishing the instruction information from other instruction information, to another terminal apparatus with which the instruction source terminal apparatus is directly related, and
the terminal apparatus that received the identifying information along with the instruction information, when it has not previously received identifying information expressing the same content as the identifying information, executing the predetermined processing according to the instruction indicated in the instruction information, and executing transmission processing of transmitting the received instruction information and identifying information to another terminal apparatus that is directly associated with the terminal apparatus.

3. The communications method according to claim 2, wherein the terminal apparatus that received the identifying information along with the instruction information does not transmit the instruction information and the identifying information to, of the other terminal apparatuses that are directly associated with the terminal apparatus, another terminal apparatus that has transmitted the instruction information to the terminal apparatus.

4. The communications method according to claim 2, wherein when the instruction is an instruction to respond with attributes of the terminal apparatus as the predetermined processing,
the terminal apparatus that received the identifying information along with the instruction information, when it has not previously received the identifying information expressing the same content as the identifying information, executes the predetermined processing and the transmission processing by transmitting attribute information that indicates the attributes of the terminal apparatus, the instruction information, the identifying information, and attribute information that indicates attributes of another terminal apparatus received along with the instruction information and the identifying information, to another terminal apparatus that is directly associated with the terminal apparatus, and when it has previously received the identifying information expressing the same content as the identifying information, transmits the instruction information, the identifying information, and the attribute information that indicates the attributes of the other terminal apparatus received along with the instruction information and the identifying information, to the instruction source terminal apparatus.

5. The communications method according to claim 4, wherein the terminal apparatus that received the identifying information along with the instruction information, when only one other terminal apparatus that transmitted the instruction information to the terminal apparatus is directly associated with the terminal apparatus, executes the predetermined processing and the transmission processing by transmitting the attribute information that indicates the attributes of the terminal apparatus, the instruction information, the identifying information, and the attribute information that indicates the attributes of the other terminal apparatus received along with the instruction information and the identifying information, to the instruction source terminal apparatus instead of the other terminal apparatus.

6. A network configured by a plurality of terminal apparatuses, wherein each terminal apparatus:
is directly associated with at least one other terminal apparatus, such that all of the terminal apparatuses are directly or indirectly related, and includes an address storing portion that stores an address for each other terminal apparatus with which it is directly associated, and
at least one terminal apparatus:
includes an instruction transmitting portion that, when all of the other terminal apparatuses are caused to execute predetermined processing, transmits instruction information that indicates an instruction to execute the predetermined processing along with identifying information for distinguishing the instruction information from other instruction information, to another terminal apparatus with which the terminal apparatus is directly associated, and
each terminal apparatus includes:
a receiving portion that receives the instruction information and the identifying information transmitted to the terminal apparatus, and
an instruction handling portion that, when the terminal apparatus has not previously received identifying information expressing the same content as the identifying information received with the instruction, handles the instruction by executing the predetermined processing according to the instruction indicated in the instruction information that was received along with the identifying information and transmitting the instruction information and the identifying information to another terminal apparatus directly associated with the terminal apparatus.

7. The network according to claim 6, wherein the instruction handling portion of a terminal apparatus that is not the initial transmission source of the instruction information and the identifying information does not transmit the instruction information and the identifying information to, of the other terminal apparatuses that are directly associated with the terminal apparatus, another terminal apparatus that has transmitted the instruction information and the identifying information to the terminal apparatus.

8. The network according to claim 6, wherein when the instruction is an instruction to respond with attributes of the terminal apparatus as the predetermined processing,
the instruction handling portion of a terminal apparatus that is not the initial transmission source of the instruction information and the identifying information, when it has not previously received the identifying information expressing the same content as the received identifying information, handles the instruction by transmitting attribute information that indicates the attributes of the terminal apparatus, the instruction information, the identifying information, and attribute information that indicates attributes of another terminal apparatus received along with the instruction information and the identifying information, to another terminal apparatus that is directly associated with the terminal apparatus, and when it has previously received the identifying information expressing the same content as the identifying information, handles the instruction by transmitting the instruction information, the identifying information, and the attribute information that indicates the attributes of the other terminal apparatus received along with the instruction information and the identifying information, to a terminal apparatus that is the initial transmission source.

9. The network according to claim 8, wherein the instruction handling portion of the terminal apparatus that is not the initial transmission source of the instruction information and the identifying information, when only one other terminal apparatus that transmitted the instruction information to the terminal apparatus is directly associated with the terminal apparatus, handles the instruction by transmitting the attribute information that indicates the attributes of the terminal apparatus, the instruction information, the identifying information, and the attribute information that indicates the attributes of the other terminal apparatus received along with the instruction information and the identifying information, to the terminal apparatus that is the initial transmission source instead of the other terminal apparatus.

10. An information processing apparatus used as a node of a network, comprising:
an address storing portion that stores an address for one or a plurality of other information processing apparatuses in the network that are associated with the information processing apparatus,
an instruction information transmitting portion that, when all of the other information processing apparatuses are caused to execute predetermined processing, transmits instruction information indicating an instruction to execute the predetermined processing to another information processing apparatus with which it is associated, along with identifying information for distinguishing the instruction information from other instruction information, and
an instruction handling portion that, when the instruction information and the identifying information have been received from another information processing apparatus, when identifying information expressing the same content has not been previously received, handles the instruction by executing the predetermined processing according to the instruction indicated by the instruction information and transmitting the instruction information and the identifying information to another terminal apparatus with which the information processing apparatus is associated.

11. The information processing apparatus according to claim 10, wherein the instruction handling portion does not transmit the received instruction information and identifying information to, of the other information processing apparatuses that are directly associated with the information processing apparatus, another information processing apparatus that has transmitted the instruction information to the information processing apparatus.

12. The information processing apparatus according to claim 10, wherein when the instruction is an instruction to respond with attributes of the information processing apparatus as the predetermined processing,
when the instruction handling portion has not previously received another identifying information expressing the same content as the identifying information received along with the instruction information, the instruction handling portion executes the predetermined processing by transmitting attribute information that indicates the attributes of the information processing apparatus, the instruction information, the identifying information, and attribute information that indicates attributes of another information processing apparatus received along with the instruction information and the identifying information, to another information processing apparatus that is directly associated with the information processing apparatus, and when it has previously received the other identifying information, transmits the instruction information, the identifying information, and the attribute information that indicates the attributes of the other information processing apparatus received along with the instruction information and the identifying information, to an instruction source information processing apparatus that transmitted the instruction information first.

13. The information processing apparatus according to claim 12, wherein when only one other information processing apparatus that transmitted the instruction information and the identifying information to the information processing apparatus is directly associated with the information processing apparatus, the instruction handling portion transmits the attribute information that indicates the attributes of the information processing apparatus, the instruction information, the identifying information, and the attribute information that indicates the attributes of the other information processing apparatus received along with the instruction information and the identifying information, to the instruction source information processing apparatus instead of the other information processing apparatus.
